(19) United States
(12) Patent Application Publication
(10) Pub. No.: US 2010/0015941 A1
(43) Pub. Date: Jan. 21, 2010

(54) BROADBAND ACTIVE BALUN AND BALANCED MIXER USING REACTIVE FEEDBACK

(75) Inventors: Jin-Cheol Jeong, Daejeon-city (KR); In-Bok Yom, Daejeon-city (KR); Dong-Pil Chang, Daejeon-city (KR); Dong-Hwan Shin, Daejeon-city (KR); In-Kwon Ju, Daejeon-city (KR); Youn-Sub Noh, Daejeon-city (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMNICATIONS RESEARCH INSTITUTE, DAEJEON-CITY (KR)

(21) Appl. No.: 12/517,581

(22) PCT Filed: Jun. 20, 2007
(86) PCT No.: PCT/KR07/02977

§ 371 Date: Jun. 4, 2009

(30) Foreign Application Priority Data
May 12, 2006 (KR) 10-2006-0122547

(51) Int. Cl. H04B 1/28

(52) U.S. Cl. 455/333

(57) ABSTRACT

A broadband active balun using reactive feedback and a balanced mixer using the balun are provided. The broadband active balun comprises a common gate FET having a source connected to an input terminal, a gate connected to the ground, and a drain connected to a first output terminal; a reactive impedance element having one end connected to the drain of the common gate FET and the other end connected to one of the gate and the source of the common gate FET, and a common source FET having a gate connected to the input terminal, a source connected to the ground and a drain connected to a second output terminal. Accordingly, the active balun has a small physical size and a wide frequency band.

### CROSS-REFERENCE TO RELATED PATENT APPLICATION

This application claims the benefit of Korean Patent Application No. 10-2006-0122547, filed on Dec. 5, 2006, in the Korean Intellectual Property Office, the disclosure of which is incorporated herein in its entirety by reference.

### BACKGROUND OF THE INVENTION

1. Field of the Invention

The present invention relates to a broadband active balun used in a balanced mixer, and more particularly, to a broadband active balun that includes an inductor and a capacitor added to a common gate field effect transistor (FET) to improve frequency characteristic and is easily applied to a microwave monolithic integrated circuit (MMIC) and a balanced mixer employing the same.

2. Description of the Related Art

Balanced mixers are used in various RF systems because they have high harmonic removal capability and wide dynamic range. The balanced mixers require two signals having the same magnitude and opposite phases. Baluns provide the signals to the balanced mixers. The baluns are divided into a passive balun and an active balun. While the passive balun is generally used in the balanced mixers, it is difficult to apply the passive balun to MMIC other than millimeter-wave MMIC because it has a large physical size. The active balun has a small physical size but it has a narrow bandwidth.

Conventional baluns are designed using passive elements such as Lange coupler, Rat race coupler and Directional coupler. It is known that the frequency bands of these couplers correspond to 10% through 15% of the start frequency.

To realize a broadband balun, Marchand balun in which two couplers, each ¼ wavelength long, use the middle portion of a coupled line with both ends grounded as a load was developed. It is known that the frequency band of the Marchand balun is up to 1 octave of the start frequency.

In the case of a ring coupler, 0.75 wavelength line is replaced with a ¼-wavelength long coupled line in to increase the frequency band to 1 octave, which is disclosed in an article entitled “A wideband Stripline Ring Hybrid,” in IEEE Transactions Microwave Theory and Technique, MTT-16, 1968, P. 361.

In the case of Marchand balun, a plurality of coupled lines are added in parallel to increase the frequency band to 6 octaves, which is disclosed in an article entitled “Exact Design of the Marchand Balun,” in Microwave J., Vol. 23, No. 5, 1980, pp. 99-102 and an article entitled “A Designer's Guide to Planar Mixer Baluns,” by Hallford, B. R., in Microwaves, December 1979, pp. 52-57.

However, the aforementioned passive baluns require ¼-wavelength long. In particular, the Marchand balun requires at least ½-wavelength long. For example, when a balun operating at 1 GHz is constructed using a GaAs MMIC (er=12.9, t=0.1 mm), ¼ wavelength corresponds to 26 mm, and thus MMIC having a size of several mm cannot construct the balun. When the operating frequency is tens GHz, ¼ wavelength is reduced so that the aforementioned passive baluns can be used.

Active balun having a small physical size are used in a relatively low frequency band. Active baluns using FETs include a circuit having a gate as an input terminal and a source and a drain as two output terminals, a circuit in which the gate of a common source FET is connected to the source of a common gate FET and used as an input terminal and the drains of the common source FET and the common gate FET are used as two output terminals, and a differential amplifier circuit. These active baluns have narrow bandwidths, and thus studies for widening the bandwidths have been carried out.

A balun having a gate as an input terminal and a drain and a source as two output terminals is disclosed in U.S. Pat. No. 5,039,891 entitled “Planar Broadband FET Balun”, in which a plurality of inductors and capacitors are connected to the input terminal and the output terminals of the balun to improve frequency characteristic and increase the performance of output phase difference of 180°±5° and magnitude difference of ±1.5 dB to 2 through 22 GHz. However, when the balun is configured using MMIC, its size is considerably increased because a number of inductors and capacitors (in this case, total 8) are used.

In the case of balun using a common source FET and a common gate FET, the examples applying a principle of broadband using such as distributed amplifier in which a plurality of baluns are connected in series through a microstrip line are disclosed in many articles. Among them, “A Double Balanced 3-18 GHz Resistive HEMT Monolithic Mixer,” by T. H. Chen, et. al., in IEEE Microwave and Millimeter-Wave Monolithic Circuits Symposium, 1992, pp. 167-170 discloses that the performance of output phase difference of 180°±10° and magnitude difference of ±1.5 dB is improved to 1.5 through 15.5 GHz. However, the size and power consumption of the balun circuit are increased because a large number of FETs are used.

In an article entitled “A Novel Broadband Active Balun”, by Munenari Kawashima, et. al., in 33rd European Microwave Conference, 2003, pp. 495-498, an additional common gate FET is connected to the drain of a common gate FET to improve the performance of output phase difference of 180°±5° and magnitude difference of ±0.5 dB to 0.5 through 10 GHz. According to this document, an active balun configured only using a common source FET and a common gate FET without having an additional circuit has output phase difference of 180°±25° at a frequency lower than 10 GHz. When the output phase difference is limited to 180°±5°, the balun has frequency characteristic of 0.5 through 2 GHz. However, the balun circuit having an additional common gate FET requires an additional bias circuit for driving the additional common gate FET, and thus a chip area and power consumption are increased.

FIG. 1 is a circuit diagram of a conventional balun circuit using a common source FET 101 and a common gate FET 102. Referring to FIG. 1, the gate of the common source FET 101 is connected to the source of the common gate FET 102 and used as an input terminal 103, and the drains of the common source FET 101 and the common gate FET 102 are used as two output terminals 104 and 105.

FIG. 2A is a small signal equivalent circuit diagram of the common source FET 101 illustrated in FIG. 1 and FIG. 2B is a small signal equivalent circuit diagram of the common gate FET 102 illustrated in FIG. 1.

The article entitled “A Novel Broadband Active Balun”, by Munenari Kawashima, et. al., in 33rd European Microwave Conference, 2003, pp. 495-498 discloses a method of obtaining the ratio of an output signal to an input signal using an equivalent circuit. Referring to this document, the ratio of the output signal to the input signal in the common source FET (CSF) 101 illustrated in FIG. 2A, that is, the ratio of the signal at the output terminal 104 to the signal at the input terminal 103 (S21)_{CSF}, and the phase of the output signal (∠S21)_{CSF} are represented as follows.

$$\begin{matrix}{( S 21 )}_{CSF} = \frac{- 2 {g}_{\text{?}} {Z}_{L}}{1 + jω {C}_{\text{?}} {Z}_{S}} & ( 1 ) \\ {( ∠S 21 )}_{CSF} = {tan}^{- 1} ( - ω {C}_{\text{?}} {Z}_{S} ) \\ \text{?} \text{indicates text missing or illegible when filed} & ( 2 )\end{matrix}$$

The ratio of the output signal to the input signal in the common gate FET 102 illustrated in FIG. 2B, that is, the ratio of the signal at the output terminal 105 to the signal at the input terminal 103 (S21)_{CGF} and the phase of the output signal (∠S21)_{CGF} are represented as follows.

$$\begin{matrix}{( S 21 )}_{CGF} = \frac{2 {g}_{\text{?}} {Z}_{L}}{1 + ( jω {C}_{\text{?}} + {g}_{\text{?}} ) {Z}_{S}} & ( 3 ) \\ {( ∠S 21 )}_{CGF} = {tan}^{- 1} ( \frac{- ω {C}_{\text{?}} {Z}_{S}}{1 + {g}_{\text{?}} {Z}_{S}} ) \\ \text{?} \text{indicates text missing or illegible when filed} & ( 4 )\end{matrix}$$

Since the sign (−) of equation 1 is different from the sign (+) of equation 3, the two output signals of the balun circuit have opposite phases (having a difference of 1800 between them). The magnitudes of the two output signals become identical to each other when the biases of the common source FET 101 and the common gate FET 102 are appropriately controlled. Accordingly, the circuit illustrated in FIG. 1 operates as a balun outputting two signals having the same magnitude and opposite phases. Referring to equations 2 and 4, however, the phases decrease according to frequency and the gradient of reduction in the phase in equation 2 is larger than that in equation 4, and thus the phase difference between the common source FET 101 and the common gate FET 102 deviates from 180° as frequency grows higher. Accordingly, a balun device using a common gate FET and a common source FET requires an active balun circuit having a small physical size and broadband frequency characteristic.

### SUMMARY OF THE INVENTION

The present invention provides an active balun circuit having a small physical size and excellent frequency band characteristic by using a reactive feedback circuit and a balanced mixer using the balun circuit.

According to an aspect of the present invention, there is provided a broadband active balun comprising a common gate FET having a source connected to an input terminal, a gate connected to the ground, and a drain connected to a first output terminal, a reactive impedance element having one end connected to the drain of the common gate FET and the other end connected to one of the gate and the source of the common gate FET, and a common source FET having a gate connected to the input terminal, a source connected to the ground, and a drain connected to a second output terminal.

The reactive impedance element may be a capacitor having one end connected to the drain of the common gate FET and the other end connected to the gate of the common gate FET or an inductor having one end connected to the drain of the common gate FET and the other end connected to the source of the common gate FET.

According to another aspect of the present invention, there is provided a broadband active balun comprising a common gate FET having a source connected to an input terminal, a gate connected to the ground, and a drain connected to a first output terminal, a capacitor having one end connected to the gate of the common gate FET and the other end connected to drain of the common gate FET; an inductor having one end connected to the source of the common gate FET and the other end connected to the drain of the common gate FET; and a common source FET having a gate connected to the input terminal, a source connected to the ground, and a drain connected to a second output terminal.

According to another aspect of the present invention, there is provided a balanced mixer including a balun outputting signals having the same magnitude and opposite phases, in which the balun comprises a common gate FET having a source connected to an input terminal, a gate connected to the ground, and a drain connected to a first output terminal, a reactive impedance element having one end connected to the drain of the common gate FET and the other end connected to one of the gate and the source of the common gate FET, and a common source FET having a gate connected to the input terminal, a source connected to the ground, and a drain connected to a second output terminal.

According to another aspect of the present invention, there is provided a balanced mixer including a balun outputting signals having the same magnitude and opposite phases, in which the balun comprises a common gate FET having a source connected to an input terminal, a gate connected to the ground, and a drain connected to a first output terminal, a capacitor having one end connected to the gate of the common gate FET and the other end connected to drain of the common gate FET, an inductor having one end connected to the source of the common gate FET and the other end connected to the drain of the common gate FET, and a common source FET having a gate connected to the input terminal, a source connected to the ground, and a drain connected to a second output terminal.

### BRIEF DESCRIPTION OF THE DRAWINGS

The above and other features and advantages of the present invention will become more apparent by describing in detail exemplary embodiments thereof with reference to the attached drawings in which:

FIG. 1 is a circuit diagram of a conventional active balun circuit including a common source FET and a common gate FET;

FIG. 2A is a small signal equivalent circuit diagram of a common source FET for analyzing the circuit illustrated in FIG. 1;

FIG. 2B is a small signal equivalent circuit diagram of a common gate FET for analyzing the circuit illustrated in FIG. 1;

FIG. 3A is a circuit diagram of an active balun circuit including a common gate FET to which a capacitor is connected and a common source FET according to an embodiment of the present invention;

FIG. 3B is a small signal equivalent circuit diagram for analyzing the circuit illustrated in FIG. 3A;

FIG. 4A is a circuit diagram of an active balun circuit including a common gate FET to which an inductor is connected and a common source FET according to another embodiment of the present invention;

FIG. 4B is a small signal equivalent circuit diagram for analyzing the circuit illustrated in FIG. 4A;

FIG. 5A is an equivalent circuit diagram illustrating the frequency characteristic of the capacitor included in the circuit illustrated in FIG. 3A;

FIG. 5B is an equivalent circuit diagram illustrating the frequency characteristic of the inductor included in the circuit illustrated in FIG. 4A;

FIG. 6A is a circuit diagram of an active balun circuit including a common gate FET to which a capacitor and an inductor are connected and a common source FET according to another embodiment of the present invention;

FIG. 6B is a small signal equivalent circuit diagram for analyzing the circuit illustrated in FIG. 6A;

FIG. 7A is a characteristic diagram illustrating the improved frequency characteristic of the circuit illustrated in FIG. 6A;

FIG. 7B is a characteristic diagram illustrating the improved frequency characteristic of the circuit illustrated in FIG. 3A; and

FIG. 7C is a characteristic diagram illustrating the improved frequency characteristic of the circuit illustrated in FIG. 4A.

### DETAILED DESCRIPTION OF THE INVENTION

The present invention will now be described more fully with reference to the accompanying drawings, in which exemplary embodiments of the invention are shown. Throughout the drawings, like reference numerals refer to like elements.

When it is determined that the detailed descriptions of known techniques or structures related to the present invention depart from the scope of the invention, the detailed descriptions will be omitted.

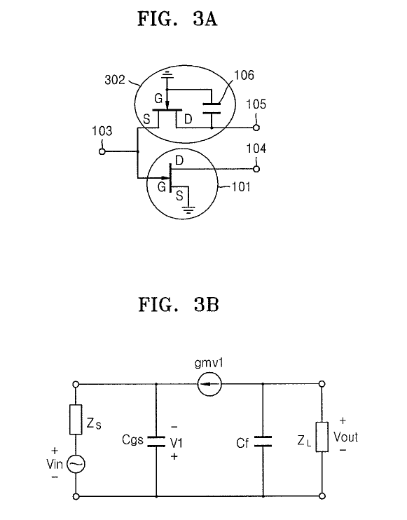

FIG. 3A is a circuit diagram of an active balun circuit including a common gate FET 302 to which a capacitor 106 is connected and a common source FET 101 according to an embodiment of the present invention. The capacitor 106 is connected between the drain and the gate of the common gate FET 302.

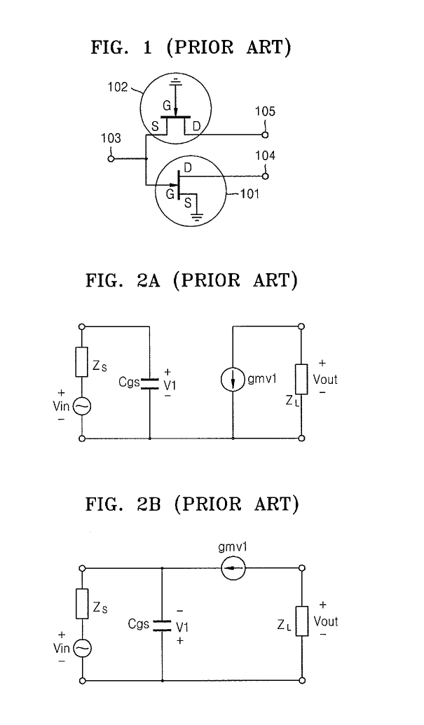

The phase of the signal at the output terminal 105 of the common gate FET of the conventional balun circuit illustrated in FIG. 1 decreases more slowly than the phase of the signal at the output terminal 104 of the common source FET.

However, the phase of the signal at the output terminal 105 of the active balun circuit illustrated in FIG. 3A decreases rapidly according to the feedback circuit formed by the common gate FET 302 with the capacitor 106, and thus the gradient of the phase of the signal at the output terminal 105 according to frequency becomes identical to the gradient of the phase of the signal at the output terminal 104 of the common source FET 101 according to frequency. Variations in the magnitudes of the signals at the output terminals 104 and 105 due to the capacitor 106 become identical to each other by controlling the biases of the two FETs 101 and 302.

FIG. 3B is a small signal equivalent circuit diagram for analyzing the active balun circuit illustrated in FIG. 3A. The ratio of the output signal to the input signal (S21)_{CGF}_{_{—}}_{Cf} in the active balun circuit illustrated in FIG. 3B and the phase of the output signal (∠S21)_{CGF}_{_{—}}_{Cf} are represented as follows.

$$\begin{matrix}{( S 21 )}_{CGF \_ Cf} = \frac{2 {g}_{\text{?}} {Z}_{L}}{\begin{matrix}1 + {g}_{\text{?}} {Z}_{S} - {ω}^{2} {C}_{\text{?}} {C}_{f} {Z}_{S} {Z}_{L} + \\ j ω ( {C}_{\text{?}} {Z}_{S} + {C}_{f} {Z}_{L} + {g}_{\text{?}} {C}_{f} {Z}_{S} {Z}_{L} )\end{matrix}} & ( 5 ) \\ {( ∠S 21 )}_{CGF \_ Cf} = {tan}^{- 1} ( \frac{- ω ( {C}_{\text{?}} {Z}_{S} + {C}_{f} {Z}_{L} + {g}_{\text{?}} {C}_{f} {Z}_{S} {Z}_{L} )}{1 + {g}_{\text{?}} {Z}_{S} - {ω}^{2} {C}_{\text{?}} {C}_{f} {Z}_{S} {Z}_{L}} ) \\ \text{?} \text{indicates text missing or illegible when filed} & ( 6 )\end{matrix}$$

In equation 6, when w²C_{gs}C_{f}Z_{S}Z_{L}<<l (which is a general case when C_{f} is smaller than 1 pF and frequency is lower than 100 GHz) and C_{f} is set as follows,

$${C}_{f} = \frac{{g}_{\text{?}} {C}_{\text{?}} {Z}_{S}^{2}}{( 1 + {g}_{\text{?}} {Z}_{S} ) {Z}_{L}} \\ \text{?} \text{indicates text missing or illegible when filed} \qquad ( 7 )$$

Equation 6 becomes identical to equation 2, and thus the phase gradient of the signal at the input terminal becomes identical to the phase gradient of the signal at the output terminal.

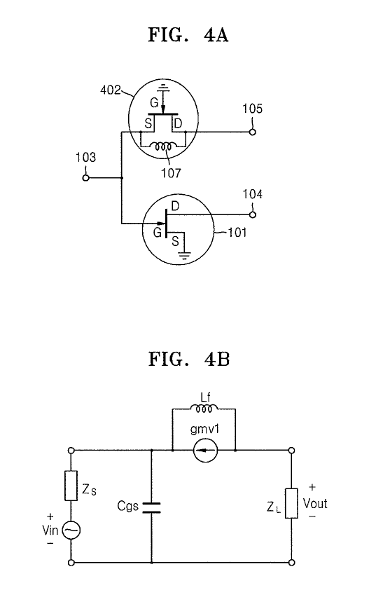

FIG. 4A is a circuit diagram of an active balun circuit including a common gate FET 402 to which an inductor 107 is connected and a common source FET 101 according to another embodiment of the present invention. The inductor 107 is connected between the drain and the source of the common gate FET 402.

The phase of the signal at the output terminal 105 of the common gate FET of the conventional balun circuit illustrated in FIG. 1 decreases more slowly than the phase of the signal at the output terminal 104 of the common source FET.

However, the phase of the signal at the output terminal 105 of the active balun circuit illustrated in FIG. 4A decreases rapidly according to the feedback circuit formed by the common gate FET 402 with the inductor 107, and thus the gradient of the phase of the signal at the output terminal 105 according to frequency becomes identical to the gradient of the phase of the signal at the output terminal 104 of the common source FET 101 according to frequency. Variations in the magnitudes of the signals at the output terminals 104 and 105 due to the inductor 107 become identical to each other by controlling the biases of the two FETs 101 and 402.

FIG. 4B is a small signal equivalent circuit diagram for analyzing the active balun circuit illustrated in FIG. 4A. The ratio of the output signal to the input signal (S21)_{CGF}_{_{—}}_{Lf} in the active balun circuit illustrated in FIG. 4B and the phase of the output signal (∠S21)_{CGF}_{_{—}}_{Lf} are represented as follows.

$$\begin{matrix}{( S 21 )}_{CGF \_ Lf} = \frac{2 ( 1 + jω {g}_{\text{?}} {L}_{f} )}{\begin{matrix}1 + {Z}_{S} / {Z}_{L} + jω \\ ( {C}_{\text{?}} {Z}_{S} + {g}_{\text{?}} {L}_{f} {Z}_{S} / {Z}_{L} + {L}_{f} / {Z}_{L} )\end{matrix}} & ( 8 ) \\ {( ∠S 21 )}_{CGF \_ Lf} = {tan}^{- 1} ( \frac{- ω ( {C}_{\text{?}} {Z}_{S} + {L}_{f} / {Z}_{L} - {g}_{\text{?}} {L}_{f} )}{\begin{matrix}1 + {Z}_{S} / {Z}_{L} - {ω}^{2} {g}_{\text{?}} {L}_{f} \\ ( {C}_{\text{?}} {Z}_{S} + {g}_{\text{?}} {L}_{f} {Z}_{S} / {Z}_{L} + {L}_{f} / {Z}_{L} )\end{matrix}} ) \\ \text{?} \text{indicates text missing or illegible when filed} & ( 9 )\end{matrix}$$

In equation 9, when w²gₘL_{f}(C_{gs}Z_{S}+gₘL_{f}Z_{S}/Z_{L}+L_{f}/Z_{L})<<l (which is a general case when L_{f} is smaller than 1 nH and frequency is lower than 100 GHz) and L_{f} is set as follows,

$${L}_{f} = \frac{{C}_{\text{?}} {Z}_{S}^{2}}{1 - {g}_{\text{?}} {Z}_{L}} \\ \text{?} \text{indicates text missing or illegible when filed} \qquad ( 10 )$$

Equation 9 becomes identical to equation 2, and thus the phase gradient of the signal at the input terminal becomes identical to the phase gradient of the signal at the output terminal.

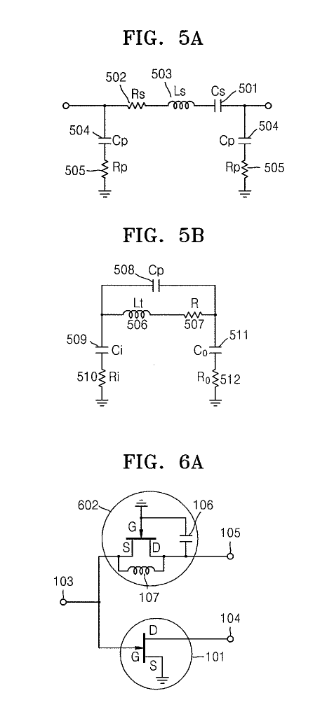

To verify the aforementioned circuit configuration, design examples using elements used in MMIC are illustrated in FIGS. 5A and 5B.

The characteristics of capacitors and inductors considerably deviate from ideal values as frequency grows higher, and thus equivalent circuits corresponding to the characteristics are usually used.

FIG. 5A is an equivalent circuit diagram illustrating the frequency characteristic of an interdigital capacitor. The interdigital capacitor is used as the capacitor included in the active balun circuit according to the present invention because the capacitor used in the active balun circuit according to the present invention must have very small capacitance and be useful to MMIC.

Referring to FIG. 5A, a resistor Rs 502 representing a conductor loss and an inductor Ls 503 are serially connected to a capacitor Cs 501, and a capacitor Cp 504 and a resistor Rp 505 for representing capacitance generated due to the thickness of a substrate are serially connected each other. One end of the capacitor Cp 504 is connected to one end of the resistor Rs 502 and one end of the other capacitor Cp 504 is connected to one end of the capacitor Cs 501. And one ends of the resistors Rp 505 are grounded.

FIG. 5B is an equivalent circuit diagram illustrating the frequency characteristic of the inductor included in the active balun circuit according to the present invention.

Referring to FIG. 5B, a resistor R 507 representing a conductor loss of an inductor Lt 506 is serially connected to the inductor Lt 506, and a capacitor Cp 508 representing interference with the inductor line is connected in parallel with the inductor Lt 506 and the resistor R 507. In addition, a capacitor Ci 509 and a resistor Ri 510 inside a spiral and a capacitor Co 511 and a resistor Ro 512 outside the spiral, which represent capacitance generated due to the thickness of a substrate, are serially connected. One ends of the capacitor Ci 509 and the capacitor Cp 508 are connected to one ends of the inductor Lt 506 and the resistor R 507, respectively. And one ends of the resistor Ri 510 and the resistor Ro 512 are grounded.

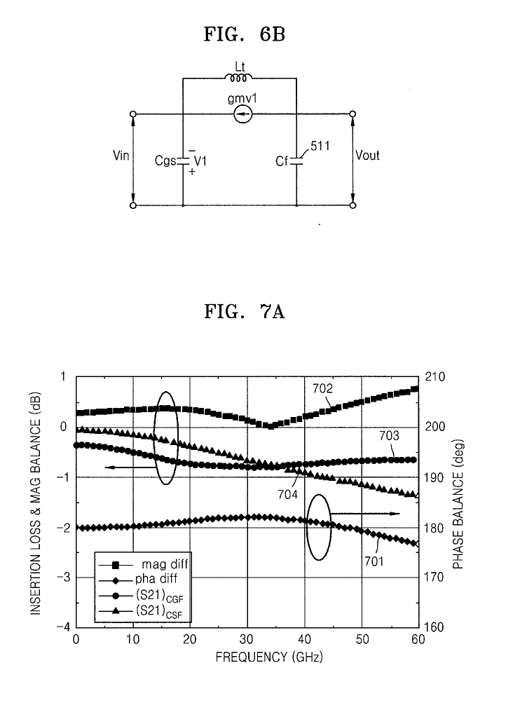

FIG. 6A is a circuit diagram of an active balun circuit including a common source FET 101 and a common gate FET 602 to which a capacitor 106 and an inductor 107 are connected according to another embodiment of the present invention, and FIG. 6B is a small signal equivalent circuit diagram for analyzing the active balun circuit illustrated in FIG. 6A.

Referring to FIGS. 6A and 6B, the capacitor 106 is connected between the drain and the gate of the common gate FET 602 and the inductor 107 is connected between the drain and the source of the common gate FET 602 in order to improve the frequency characteristic of the active balun circuit. Accordingly, the frequency characteristics of the signals output from the output terminal 105 of the common gate FET 602 including both the capacitor 106 and the inductor 107, which are reactive impedance elements, and the output terminal 104 of the common source FET 101 are improved over those of the balun circuit including the common gate FET to which one of the capacitor and the inductor is connected.

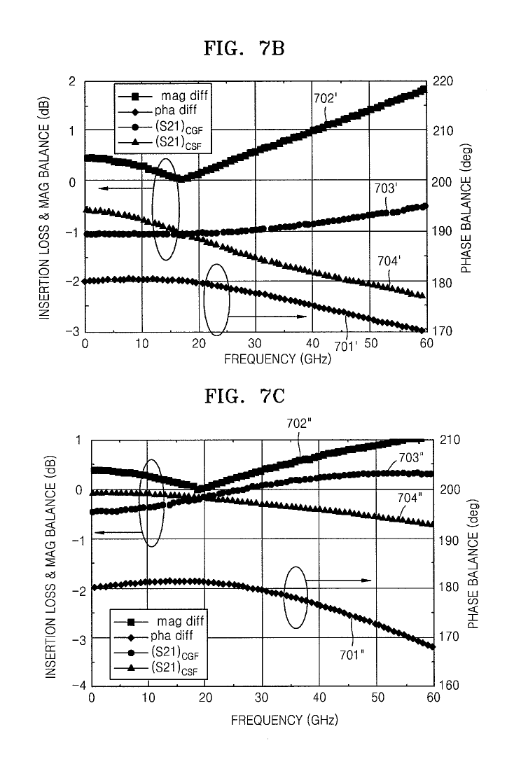

FIGS. 7A, 7B and 7C are characteristic diagrams illustrating the improved frequency characteristics of the active balun circuits illustrated in FIGS. 6A, 3A and 4A. The balun circuits are designed under the following bias conditions of nodes and conditions of a capacitor C_{f} and an inductor L_{f} for minimizing a phase difference and a magnitude difference. The capacitor and the inductor illustrated in FIGS. 5A and 5B are used as the capacitor C_{f} and the inductor L_{f}. A p-HEMT having a gate length of 0.15 μm and a gate width of 40 μm is used as an active element, that is, FET, included in the balun circuits.
Bias conditions of active elements;
Node 104: 1.22V, node 605:0.46V, node 108:-0.18V, node 109:-0.88V Equivalent circuit parameters of capacitor C_{f} 106;
Cs=0.008 pF, Rs=2.03 ohm, Ls=0.147 nH, Rp=228 ohm, Cp=0.021 pF Equivalent circuit parameters of inductor L_{f} 107;
Lt=0.187 nH, R=1.4 ohm, Cp=−0.029 pF, Ci=0.0033 pF, Co=0.0044 pF, Ri=30 ohm, Ro=15 ohm

Referring to FIG. 7A, a curve 701 indicates a phase difference between the signals at the two output terminals 104 and 105 and a curve 702 represents a magnitude difference between the signals at the two output terminals 104 and 105. In addition, a curve 703 indicates the ratio of the signal at the output terminal 104 to the signal at the input terminal 103 and a curve 704 represents the ratio of the signal at the output terminal 605 to the signal at the input terminal 103. And the value of the curves 702, 703, and 704 is dB. Two ovals and arrows represent which one of two Y-axes is indicated by parameters of the curves 701, 702, 703 and 704.

The graph illustrated in FIG. 7A represents that the performance of output phase difference of 180°±5° and magnitude difference of ±1 dB is shown up to DC˜60 GHz under the bias condition optimized to C_{f} represented by equation 7, L_{f} represented by equation 10, the phase difference and the magnitude difference. This corresponds to the best performance over the active and passive baluns that have been developed so far.

Referring to FIG. 7B, a curve 701′ indicates a phase difference between the signals at the two output terminals 104 and 105 and a curve 702′ represents a magnitude difference between the signals at the two output terminals 104 and 105. In addition, a curve 703′ indicates the ratio of the signal at the output terminal 104 to the signal at the input terminal 103 and a curve 704′ represents the ratio of the signal at the output terminal 605 to the signal at the input terminal 103. And the value of the curves 702′, 703′, and 704′ is dB.

That is, the balun circuit having excellent frequency characteristic can be obtained only with the capacitor C_{f} represented by equation 7 and the performance of output phase of 180°±5° and magnitude of ±1 dB can be improved to DC˜40 GHz with the optimized bias and capacitance minimizing the phase and the magnitude.

Referring to FIG. 7C, a curve 701″ indicates a phase difference between the signals at the two output terminals 104 and 105 and a curve 702″ represents a magnitude difference between the signals at the two output terminals 104 and 105. In addition, a curve 703″ indicates the ratio of the signal at the output terminal 104 to the signal at the input terminal 103 and a curve 704″ represents the ratio of the signal at the output terminal 605 to the signal at the input terminal 103. And the value of the curves 702″, 703″ and 704″ is dB.

That is, the balun circuit having excellent frequency characteristic can be obtained only with L_{f} represented by equation 10 and the performance of output phase of 180°±5° and magnitude of ±1 dB can be improved to DC˜45 GHz with the optimized bias and inductance minimizing the phase and the magnitude.

The above-described broadband active balun according to the present invention outputs signals having the same magnitude and opposite phases and it can be used in a balanced mixer. The components of the balanced mixer other than the broadband active balun are well-known in the art so that detailed explanation thereof is omitted.

As described above, the present invention connects a capacitor between the drain and the gate of a common gate FET and connects an inductor between the drain and the source of a common gate FET to construct a reactive feedback circuit in an active balun circuit including the common source FET and the common gate FET to reduce a phase difference between signals of two output terminals of the active balun circuit and improve the frequency characteristic of the active balun circuit.

Furthermore, the active balun according to the present invention can be applied to circuits requiring excellent frequency characteristic, such as microwave communication components and MMIC, because the active balun has a small size.

Moreover, the active balun according to the present invention has a wide frequency band, and thus the frequency band of a balanced mixer using the active balun is increased. Accordingly, the active balun can be used in systems having various frequency bands.

The invention may, however, be embodied in many different forms and should not be construed as being limited to the embodiments set forth herein; rather, these embodiments are provided so that this disclosure will be thorough and complete, and will fully convey the concept of the invention to those skilled in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A broadband active balun comprising:
a common gate FET having a source connected to an input terminal, a gate connected to the ground, and a drain connected to a first output terminal;
a reactive impedance element having one end connected to the drain of the common gate FET and the other end connected to one of the gate and the source of the common gate FET; and
a common source FET having a gate connected to the input terminal, a source connected to the ground and a drain connected to a second output terminal.

2. The broadband active balun of claim 1, wherein the reactive impedance element is a capacitor of which the other end is connected to the gate of the common gate FET.

3. The broadband active balun of claim 1, wherein the reactive impedance element is an inductor of which the other end is connected to the source of the common gate FET.

4. A broadband active balun comprising:
a common gate FET having a source connected to an input terminal, a gate connected to the ground, and a drain connected to a first output terminal;
a capacitor having one end connected to the gate of the common gate FET and the other end connected to drain of the common gate FET;
an inductor having one end connected to the source of the common gate FET and the other end connected to the drain of the common gate FET; and
a common source FET having a gate connected to the input terminal, a source connected to the ground, and a drain connected to a second output terminal.

5. A balanced mixer including a balun outputting signals having the same magnitude and opposite phases, wherein the balun comprises:
a common gate FET having a source connected to an input terminal, a gate connected to the ground, and a drain connected to a first output terminal;
a reactive impedance element having one end connected to the drain of the common gate FET and the other end connected to one of the gate and the source of the common gate FET; and
a common source FET having a gate connected to the input terminal, a source connected to the ground, and a drain connected to a second output terminal.

6. The balanced mixer of claim 5, wherein the reactive impedance element is a capacitor of which the other end is connected to the gate of the common gate FET.

7. The balanced mixer of claim 5, wherein the reactive impedance element is an inductor of which the other end is connected to the source of the common gate FET.

8. A balanced mixer including a balun outputting signals having the same magnitude and opposite phases, wherein the balun comprises:
a common gate FET having a source connected to an input terminal, a gate connected to the ground, and a drain connected to a first output terminal;
a capacitor having one end connected to the gate of the common gate FET and the other end connected to drain of the common gate FET;
an inductor having one end connected to the source of the common gate FET and the other end connected to the drain of the common gate FET; and
a common source FET having a gate connected to the input terminal, a source connected to the ground, and a drain connected to a second output terminal.
